(19) United States
(12) Patent Application Publication
(10) Pub. No.: US 2005/0108768 A1
(43) Pub. Date: May 19, 2005

(54) Systems and methods for providing dynamic loading of applications over a network

(76) Inventors: Sachin Govind Deshpande, Vancouver, WA (US); Jon Arthur Fairhurst, Camas, WA (US)

Correspondence Address: Michael F. Krieger;Kirton & McConkie, 1800 Eagle Gate Tower, 60 East South Temple, Salt Lake City, UT, 84111, US

(21) Appl. No.: 10/712,241

(22) Filed: Nov. 13, 2003

(51) Int. Cl. H04N 7/173; H04N 7/16; G06F 15/16

(52) U.S. Cl. 725/115; 725/145; 709/217; 709/219; 725/94

(57) ABSTRACT

Systems and methods for providing dynamic loading of applications over a network, wherein the loading is seamless and is initiated by a television. In a networked system that includes a television for rendering programming and a remote computer device having an application, the television dynamically determines that at least a portion of a remote application is needed and utilizes a network file system protocol to dynamically obtain the portion from the remote computer device, wherein the portion is obtained so as to be transparent to the view of the television and as needed by the television.

### BACKGROUND OF THE INVENTION

1. Field of the Invention

The present invention relates to remote access to an application, file or resource. In particular, the present invention relates to systems and methods for providing dynamic loading of applications over a network, wherein the loading is seamless and is initiated by a television.

2. Background and Related Art

With the emergence of the personal computer, obtaining data and information has become increasingly important to both individuals and companies. A variety of computer system configurations are currently available that allow information to be obtained or otherwise utilized.

In some techniques, information is obtained across a network and stored locally. The local information can then be utilized. Individuals transmit information using a variety of techniques. For example, information is exchanged across local area networks, across wide area networks, via email, across wireless networks, and the like.

However, while a variety of techniques currently exist that are used to exchange information, large sums of time and money are being invested to develop new techniques to enhance data exchange because challenges exist with current technologies. Accordingly, it would be an improvement in the art to augment or even replace current techniques with other techniques.

### SUMMARY OF THE INVENTION

The present invention relates to remote access to an application, file or resource. In particular, the present invention relates to systems and methods for providing dynamic loading of applications over a network, wherein the loading is seamless and is initiated by a television.

Implementation of the present invention takes place in association with a networked system that includes a television for rendering programming and a remote computer device. The television is a local client of the networked system. At least a portion of an application is dynamically obtained by the television from the remote computer device over a network. The television dynamically determines a need for at least a portion of a remote application, which is located at the remote computer device. The television utilizes a network file system protocol to dynamically obtain the portion from the remote computer device in a manner that is transparent to the viewer of the television.

In at least one implementation, the methods and processes of the present invention are utilized in association with a television that employs Aquos TV from Sharp® Laboratories of America, Inc. Utilization of the methods and processes of the present invention gives Aquos TV the ability to use applications that are located on a remote computer device in the same manner as if they are locally installed applications. The Aquos TV may be notified in real-time regarding new applications available on the remote computer device for seamless access. A network based file system protocol is utilized to obtain a seamless remote access. The protocol as disclosed herein is used to detect new applications and to send events to notify a viewer at the television. A server of the networked system may dynamically send “NewAPP” and “Deleted APP” events to the client (television) and the client will access the actual application using the network based file system protocol, which is augmented by an external mechanism to allow the sending of events to the clients.

While the methods and processes of the present invention have proven to be particularly useful in the area of Aquos TV, those skilled in the art can appreciate that the methods and processes can be used in a variety of different applications and in a variety of different areas of manufacture to provide a dynamic loading of applications over a network, wherein the loading is seamless and is initiated by a television.

Further, while a network file system protocol has proven to be particularly useful, those skilled in the art will appreciate that the methods and processes of the present invention embrace a variety of protocols, including common internet file system protocol (CIFS), network file system protocol (NFS), etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 is a representative networked system configuration in accordance with an embodiment of the present invention;

FIG. 3 is a flow chart that illustrates representative processing relating to remotely accessing information; and

FIG. 4 is a flow chart that illustrates representative interaction between server and client for establishing a connection for seamlessly utilizing remote applications and for sending and receiving events.

### DETAILED DESCRIPTION OF THE INVENTION

The present invention relates to remote access to an application, file or resource. In particular, the present invention relates to systems and methods for providing dynamic loading of applications over a network, wherein the loading is seamless and is initiated by a television.

Embodiments of the present invention take place in association with a networked system that includes a television for rendering programming and a remote computer device. The television is a local client of the networked system. An application, file or resource is dynamically obtained by the television from the remote computer device over the network. This is performed by the television dynamically determining the remote application, file or resource is needed. The television utilizes a network file system protocol to dynamically obtain the remote application, file or resource from the remote computer device on an “as-needed” basis, wherein the remote application, file or resource is obtained in a manner that is transparent to the viewer of the television.

In one embodiment, the television that employs Aquos TV from Sharp® Laboratories of America, Inc. Utilization of the methods and processes of the present invention gives Aquos TV the ability to use applications existing on a remote computer device in the same manner as if they are locally installed applications. For example, the Aquos TV may be notified in real-time regarding new applications available on the remote computer device for seamless access. As will be further discussed below, a network based file system protocol is utilized to obtain a seamless remote access. The protocol may also be used to detect a new application, file or resource, and send events to notify a viewer at the television. A server of the networked system may dynamically send “NewAPP” and “Deleted APP” events to the client (television) and the client accesses the application using the network based file system protocol, which is augmented by an external mechanism to allow sending events to the clients.

The following disclosure of the present invention is grouped into two subheadings, namely “Exemplary Operating Environment” and “Dynamic Loading of Applications.” The utilization of the subheadings is for convenience of the reader only and is not to be construed as limiting in any sense.

### Exemplary Operating Environment

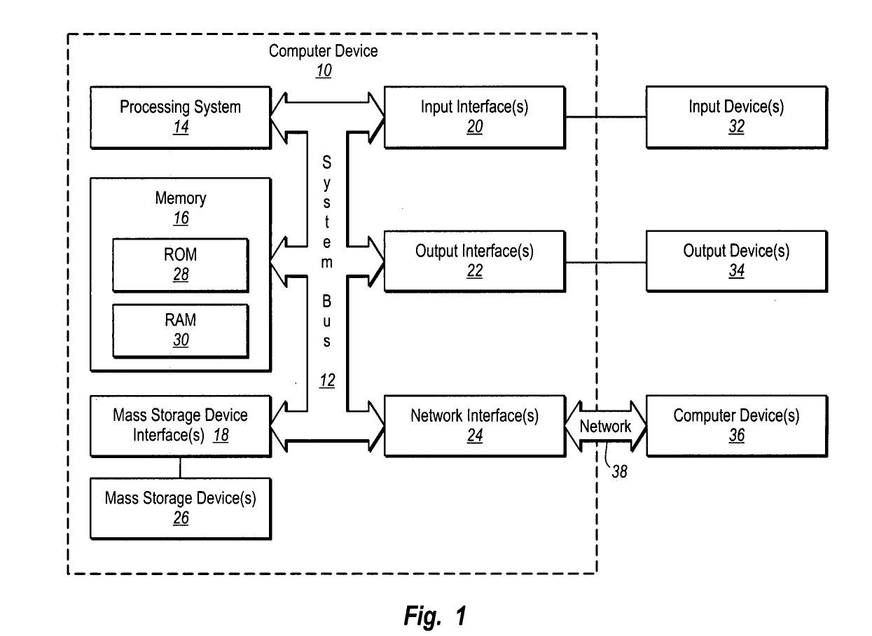

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a remote control device, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

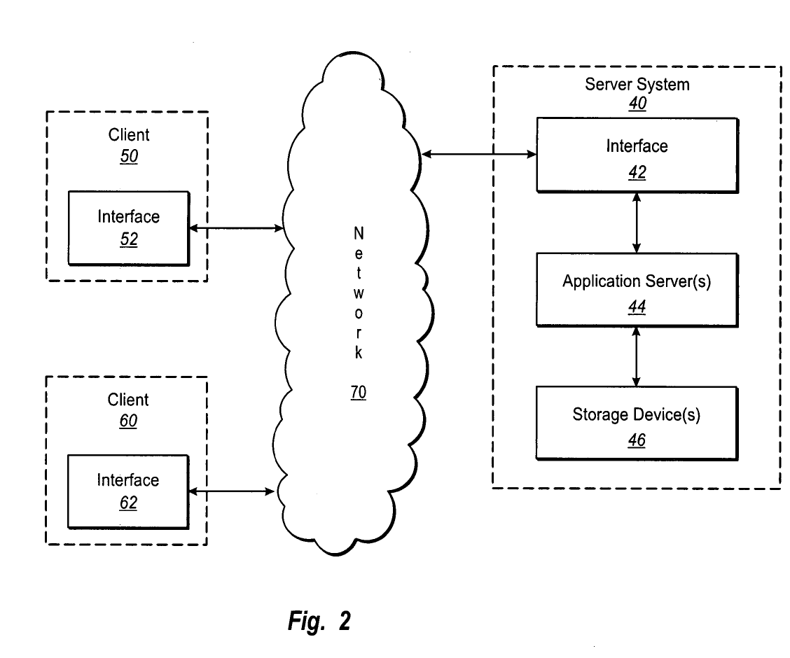

While those skilled in the art will appreciate that the invention may be practiced in networked computing environments with many types of system configurations, FIG. 2 represents an embodiment of the present invention that enables a client selectively and dynamically obtain a remote application, file or resource over a network, wherein the client is a television. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet or a local area network such as a home network.

In FIG. 2, server system 40 represents a system configuration that includes an interface 42, one or more servers 44, and a storage device 46. By way of example, server system 40 may be a single server or may be a conglomeration of servers that process and preserve high volumes of information. A resource, file, application, piece of data, or the like is preserved on storage device 46.

Clients 50 and 60 are connected to server system via network 70, and respectively include interfaces 52 and 62 to enable communication. In at least some embodiments, interfaces 42, 52 and 62 include a network file system protocol, as will be further discussed below. One of the clients, (e.g., client 50) is a television that dynamically obtains a remote application, resource, file or piece of data from server system 40 or client 60.

While the discussion above has presented a representative system configuration for implementing the present invention, those skilled in the art will appreciate that the methods of the present invention and processes thereof may be implemented in a variety of different system configurations.

### Dynamic Loading of Applications

As provided above, embodiments of the present invention embrace remote access to an application, file or resource. In particular, the present invention relates to systems and methods for providing dynamic loading of applications over a network, wherein the loading is seamless and is initiated by a television.

As illustrated in the embodiment of FIG. 2, a server (e.g., server 44) is a networked computer and a client (e.g., client 50) is a television. A protocol, such as a network file system (NFS), common internet file system (CIFS), or other protocol, is used and an underlying mechanism for dynamically loading a remote application or otherwise obtaining a remote file or resource. NFS was developed to allow a device to mount a disk partition on a remote device as if it were on a local hard drive. This allows for fast, seamless sharing of files across a network. In particular, NFS is a client/server application that allows all network users to access shared files stored on computers of different types. NFS may typically provide access to shared files through an interface called a virtual file system (VFS) that runs on top of TCP/IP. With NFS, computer devices (including a television with a processing unit) that are connected to a network can operate as a client while accessing remote applications, files or resources, and as a server while providing remote users/devices access to local shared files.

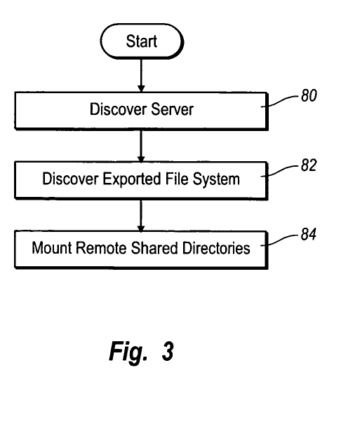

Thus, in one embodiment, an NFS server and an NFS client (Aquos TV) are used in a networked system. In this embodiment, one or more directories on the networked computer are exported through NFS and are mounted on the client (Aquos TV). As illustrated in the representative embodiment of FIG. 3, the client discovers the server at step 80, discovers the server's exported file system at step 82, and then mounts the remote shared directories at step 84.

Thus, while other techniques use NFS for remote storage as a network based file system, embodiments of the present invention use NFS by augmenting it with a mechanism which can detect new applications, remove applications and/or update existing applications and send events to notify a user at a client (television). Accordingly, the server can send “NewAPP” and “Deleted APP” events to the client and the client will access the actual application using NFS. Thus, the NFS protocol is augmented by an external mechanism to allow for the sending of events to clients.

In another embodiment, the protocol employed is a common internet file system (CIFS) protocol. CIFS is a protocol that defines a standard for remote file access. With CIFS, users with different platforms and computer devices can share files without typically having to install new software on the server or the client, especially if those devices use Microsoft® Windows operating system. CIFS runs over TCP/IP but uses the server message block (SMB) protocol found in Microsoft® Windows operating systems for file and printer access. In at least some embodiments, the network is the Internet.

While the foregoing discussion relates to NFS and CIFS, those skilled in the art will appreciate that other embodiments of the present invention embrace utilization of other protocols to perform dynamic loading of applications over a network.

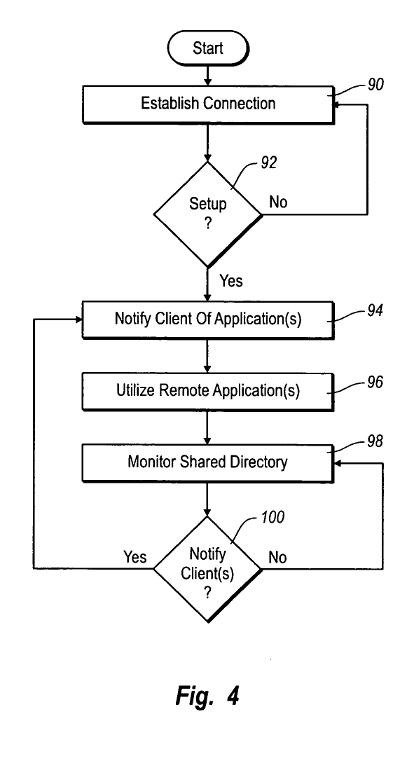

With reference now to FIG. 4, a combined flowchart is provided that illustrates an interaction between and processing at the server and the client. In FIG. 4, and apart from the protocol used, the server and client are connected to each other using a reliable connection, as illustrated at step 90. A determination is then made at decision block 92 as to whether or not the connection is setup. If it is not yes completely setup, execution returns back to step 90 to establish the connection. After the connection is setup, the server notifies the client about existing applications at step 94. At step 96, the client (e.g., Aquos TV) seamlessly uses the application that resides on the remote networked computer device (server), as if it was a locally installed application at the client. In the present embodiment, this is because the server's shared directory is mounted by the client previously as shown and described in FIG. 3.

On the remote network computer there is also a monitoring thread, which monitors the shared directory at step 98. A user can drag and drop or copy any new application to the shared directory and the monitoring thread will detect this event and will notify the client about new application. Accordingly, at decision block 100 a determination is made as to whether or not to notify the client. If it is determined at decision block 100 to notify the client, execution returns back to step 94. Otherwise execution returns back to step 98.

In one embodiment, the shell notification mechanism of Microsoft® Windows is used to monitor a shared directory and to discover new applications on the server. The following pseudo-code shows this mechanism:

```
DWORD dwFlags= FILE NOTIFY CHANGE FILE NAME;
HANDLE hNotify =
FindFirstChangeNotification (monPath, FALSE, dwFlags); //monPath
            //points to the directory to monitor
if (hNotify == INVALID_HANDLE_VALUE)
{
print f (“\nCouldn't make handle to monitor”);
exit (1);
}
int term=1;
while (hNotify != INVALID_HANDLE_VALUE)
{
    while (term)
    {
      unsigned long stat =
        WaitForSingleObject (hNotify, SMALL_TIMEOUT);
      If (stat == WAIT_OBJECT_0)
      {
                term =1;
                newAppNotify ( ); //Action for new application
                if (! FindNextChangeNotification (hNotify) )
                {
                  term =0; break;
                }
          }
          else if (stat == WAIT_TIMEOUT)
            {
              term =1;
            }
          else
          {
                term =0; break;
          }
    }
```

In this embodiment, the shell notification only notifies that a directory has changed but does not report what has changed. Accordingly, in the present embodiment, the server side maintains a list of current content of the directory and compares it when any change occurs with the previous list to find out the new change. The server notifies the client about a new application by sending a message. From then on the new application is seamlessly available to the client. Similarly the server can notify the client by sending events, when a previously available application is removed or updated.

Thus, as discussed herein, the embodiments of the present invention embrace remotely accessing an application, file or resource. In particular, the present invention relates to systems and methods for providing dynamic loading of applications over a network, wherein the loading is seamless and is initiated by a television.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a networked system that includes a client and a server, a method for dynamically obtaining at least a portion of an application from the server over a network, the method comprising:
determining, at a local client device, that at least a portion of an application is needed at the local client device, wherein the portion is located at a remote server device; and
using a file system protocol to dynamically obtain the portion from the remote server device, wherein the portion is obtained so as to be transparent to the user and as needed by the local client device.

2. A method as recited in claim 1, wherein the local client device is a television.

3. A method as recited in claim 1, wherein the local client device is an Aquos TV.

4. A method as recited in claim 1, wherein the step for using the file system protocol to dynamically obtain the portion from the remote server device comprises using an internet file system protocol.

5. A method as recited in claim 1, wherein the step for using the file system protocol to dynamically obtain the portion from the remote server device comprises using a network file system (NFS) protocol.

6. A method as recited in claim 1, wherein the step for using the file system protocol to dynamically obtain the portion from the remote server device comprises using a common internet file system (CIFS) protocol.

7. A method as recited in claim 1, wherein the step for using the file system protocol to dynamically obtain the portion from the remote server device is initiated at the local client device.

8. A method as recited in claim 1, further comprising a step for using the file system protocol to dynamically obtain at least another portion of the application from another remote server device.

9. A method as recited in claim 1, further comprising a step for using the file system protocol to dynamically obtain at least a portion of another application from another remote server device.

10. A method as recited in claim 1, wherein the step for determining that at least a portion of an application is needed at the local client device further comprises a step for sending an event from the remote server device to the local client device to indicate an availability of the application.

11. A method as recited in claim 10, wherein the application is a new application.

12. A method as recited in claim 1, wherein the step for using the file system protocol to dynamically obtain the portion from the remote server device is initiated at the local client device after receiving the event from the remote server device about the availability of the new application.

13. A method as recited in claim 1, wherein the step for using the file system protocol to dynamically obtain the portion from the remote server device is initiated at the local client device after receiving input from a user.

14. A method as recited in claim 1, wherein the user input is received by the local client device from a remote control device.

15. A method as recited in claim 1, wherein the application is a new application, and wherein the method further comprises a step for monitoring a location on the remote server device to determine whether the new application is available.

16. A method as recited in claim 1, further comprising a step for sending an event from the remote server device to the local client device to indicate at least one of
(i) a removal of a first application; and
(ii) a modification to a particular application.

17. A method as recited in claim 1, further comprising a step for monitoring a location on the remote server device to determine at least one of:
(i) whether a first application is removed; and
(ii) whether a particular application is modified.

18. A networked system comprising:
a client, wherein the client includes a television that provides programming content;
a server coupled to the client via a network, wherein the server includes an application remotely preserved for the client; and
a file system protocol employed by the client and the server to allow the client to obtain at least a portion of the application remotely preserved for the client on an as-needed basis.

19. A networked system as recited in claim 18, wherein the client is an Aquos TV.

20. A networked system as recited in claim 18, wherein the file system protocol is an internet file system protocol.

21. A networked system as recited in claim 18, wherein the file system protocol is a network file system (NFS) protocol.

22. A networked system as recited in claim 18, wherein the file system protocol is a common internet file system (CIFS) protocol.

23. A networked system as recited in claim 18, further comprising a second server coupled to the network, wherein the second server includes another portion of the application remotely preserved for the client, and wherein the file system protocol is dynamically employed by the client to allow the client to obtain the another portion of the application on an as-needed basis.

24. A networked system as recited in claim 18, further comprising a second server coupled to the network, wherein the second server includes another application remotely preserved for the client, and wherein the file system protocol is dynamically employed by the client to allow the client to obtain at least a portion of the another application on an as-needed basis.

25. A networked system as recited in claim 18, further comprising an event transmitted from the server to the client to indicate at least one of:
(i) an availability of the application;
(ii) that a current application has been removed; and
(iii) that a particular application has been modified.

26. A networked system as recited in claim 25, wherein the available application is a new application.

27. A networked system as recited in claim 18, further comprising a location on the server that is monitored by the client to determine at least one of:
(i) that a new application is available;
(ii) that a particular application has been removed; and
(iii) that a current application has been modified.

28. A computer program product for implementing within a networked system a method for dynamically obtaining at least a portion of an application from a server over a network, the computer program product comprising:
a computer readable medium for providing computer program code means utilized to implement the method, wherein the computer program code means is comprised of executable code for implementing the steps for:
determining, at a local client computer device, that at least a portion of an application is needed at the local client computer device, wherein the portion is located at a remote server computer device; and
using a file system protocol to dynamically obtain the portion from the remote server computer device, wherein the portion is obtained so as to be transparent to the user and as needed by the local client computer device.

29. A computer program product as recited in claim 28, wherein the local client computer device is a television.

30. A computer program product as recited in claim 28, wherein the local client computer device is an Aquos TV.

31. A computer program product as recited in claim 28, wherein the step for using the file system protocol to dynamically obtain the portion from the remote server computer device comprises one of:
(i) using an internet file system protocol;
(ii) using a network file system (NFS) protocol; and
(iii) using a common internet file system (CIFS) protocol.

32. A computer program product as recited in claim 28, wherein the step for using the file system protocol to dynamically obtain the portion from the remote server computer device is initiated at the local client computer device.

33. A computer program product as recited in claim 28, wherein the computer program code means is further comprised of executable code for implementing the steps for using the file system protocol to dynamically obtain at least another portion of the application from another remote server computer device.

34. A computer program product as recited in claim 28, wherein the computer program code means is further comprised of executable code for implementing the steps for using the file system protocol to dynamically obtain at least a portion of another application from another remote server computer device.

35. A computer program product as recited in claim 28, wherein the step for determining that at least a portion of an application is needed at the local client computer device further comprises a step for sending an event from the remote server computer device to the local client computer device to indicate an availability of the application.

36. A computer program product as recited in claim 35, wherein the application is a new application.

37. A computer program product as recited in claim 28, wherein the step for using the file system protocol to dynamically obtain the portion from the remote server computer device is initiated at the local client computer device after receiving the event from the server about the availability of the new application.

38. A computer program product as recited in claim 28, wherein the step for using the file system protocol to dynamically obtain the portion from the remote server computer device is initiated at the local client computer device upon receiving input from a user.

39. A computer program product as recited in claim 28, wherein the user input is received by the local client computer device from a remote control device.

40. A computer program product as recited in claim 28, wherein the application is a new application, and further comprising a step for monitoring a location on the remote server computer device to determine whether the new application is available.

41. A computer program product as recited in claim 28, further comprising a step for sending an event from the remote server computer device to the local client computer device to indicate at least one of
(i) a removal of a first application; and
(ii) a modification to a particular application.

42. A computer program product as recited in claim 39, further comprising a step for monitoring a location on the remote server computer device to determine at least one of:
(i) whether a first application is removed; and
(ii) whether a particular application is modified.
